(19) United States
(12) Patent Application Publication
(10) Pub. No.: US 2009/0244305 A1
(43) Pub. Date: Oct. 1, 2009

(54) Video Recording System and Imaging Apparatus

(75) Inventors: Daisuke YOSHIDA, Yokohama (JP); Masaru Takakhashi, Hayama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/361,599

(22) Filed: Jan. 29, 2009

(30) Foreign Application Priority Data
Mar. 26, 2008 (JP) 2008-079501

(51) Int. Cl. H04N 5/225; H04N 11/04

(52) U.S. Cl. 348/220.1; 375/240.01; 375/E07.001

(57) ABSTRACT

A moving picture imaging apparatus simultaneously generates main image data and sub image data having a smaller image size, transmits the main image data to a server over a network, and stores the sub image data in a storage device. Editing or the like is performed on the sub image data. When the image data is reproduced on a television monitor or the like, the main image data is read out from the server and reproduced.

### INCORPORATION BY REFERENCE

The present application claims priority from Japanese application JP2008-079501 filed on Mar. 26, 2008, the content of which is hereby incorporated by reference into this application.

### BACKGROUND OF THE INVENTION

The present invention relates to a video recording system that comprises an imaging apparatus and an information processing apparatus, and to the imaging apparatus.

The imaging apparatus, such as a video camera or an electronic still camera, which adopts an image compression technology, such as H.264 or JPEG, has become widely available. It has also become quite common to see moving images and still images photographed by a camera or the like on a large television screen or a personal computer. At the same time, a network environment has been greatly improved, including the faster communication lines. Against this backdrop, an invention is required that transmits a photographed video image to remotely located equipment.

JP-A-2002-10184 describes its object as “to provide a video data management method and video data management system capable of storing, reproducing, or processing vide data without the use of a video recording medium.” JP-A-2002-10184 also describes a video data management system that “transfers image data photographed by a video recording device to a video management device connected to the video recording device over a network, and stores the video data transferred to the video management device in the video management system.”

JP-A-2004-328105 describes its object as “to facilitate editing of images photographed by a video camera,” and describes a video information capture system in which “a video information capture device 10 creates main image data and simple image data at the same time, records the main image data in a recording medium 20 such as a tape, and outputs the simple image data to a server device 30 over a network.”

### SUMMARY OF THE INVENTION

As more television programs are broadcast in high-definition, and TV screen size gets larger, the size of image data displayed thereon has increased, and the capacity of a storage device for storing the image data is required to be larger.

As the size of image data increases, a user of the imaging apparatus is required to use the apparatus while checking how much free space remains in the storage device. At the same time, in order to improve the operability of the imaging apparatus, a reproduction function for checking an image, such as a preview function, a thumbnail display function, or a rec-view function, is also required.

So as to cope with above problem, in the video data management system described in JP-A-2002-10184, images are transferred from the video recording device to an external device, thus making it possible to eliminate the use of a recording medium of the user's terminal or to increase the free space of the recording medium.

However, in the video data management system described in JP-A-2002-10184, when reproducing the video data again after the transmission of the video data to the video management device, the video data has to be downloaded from the video management device. This requires additional time and effort by the user.

In the video information capture system described in JP-A-2004-328105, the simple image is transmitted to the server device or the like, and so the server device is capable of managing images in an easy manner. The video information capture device is also capable of reproducing the main image.

However, what is collectively managed by the server device is the simple image data for editing. Therefore, storing the main image data with a limited storage capacity on the side of the video information capture device requires the user to pay attention, as before, to the recording time period and the number of sheets to be recorded.

In the video information capture system described in JP-A-2004-328105, in most cases, the amount of information that can be displayed by a display device equipped to the imaging apparatus is generally smaller than the amount of information that can be displayed by a contemporary TV receiver or the like. In reproducing the image data by conventional equipment, large image data is once reproduced, and when the image data is displayed, it is scaled down in accordance with the size of the display device. Therefore, the reproduction of the large image data just for the small-sized display device requires greater power consumption.

In addition, in JP-A-2004-328105, when the server device outputs the main image, the server device must receive the main image from the video information capture device after the server searched for the simple image. This requires the transmission and reception again between the server device and the video information capture device, requiring time and effort.

Therefore, it is an object of the present invention to provide a structure in which an image captured by an imaging apparatus is transmitted to an information processing device, and a decrease in free space of a storage capacity is suppressed, while keeping the usefulness of being able to reproduce the image taken by the imaging apparatus.

In order to achieve the object as mentioned above, according to the present invention, for example, the imaging apparatus produces two kinds of video information that differ from each other in size. The imaging apparatus outputs one of the two kinds of video information to external equipment and then deletes the outputted video information, and keeps the other compressed video information in a recording medium.

It is an object of the present invention to provide a structure in which an image captured by an imaging apparatus is transmitted to an information processing device, a decrease in free space of a storage capacity is suppressed, and at the same time the usefulness of being able to reproduce the image taken by the imaging apparatus is kept.

A liquid crystal display device having a low resolution is typically equipped to the imaging apparatus. However, when video is displayed only on the small display, video information having a small information volume is reproduced and displayed, thus leading to a decrease in power consumption.

If data is created such that when only a video signal having a small data size, of the two kinds of video signals, is reproduced, a reproduced image having a low-resolution is produced, and when a combination of a video signal having a large data size and the video signal having a small data size is reproduced, a reproduced image having a high-resolution is produced, then it becomes possible to display the video signal in accordance with the screen size of the display device. That is to say, when making a display only on the display device equipped to the imaging device, the video signal having a small data size can be displayed, and when making a display on the externally connected large display device, the combination of the large and small video signals can be displayed.

Furthermore, it becomes possible to make a display with a minimum power consumption during the display of the video signal on the external display device, by reproducing and displaying the combination of the video signal having a small data size and part or all of the video signal having a large data size.

When a low-delay reproduction of an image is particularly required, as in a case of a surveillance system, a video signal having a small data size, which is stored in the imaging apparatus, is preferentially displayed on the external display device and on the display device equipped to the imaging apparatus. This allows reproduction of the video without considering a delay in obtaining data from the video signal having a large data size which is externally stored.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the construction of a moving picture imaging apparatus and a data path of recording according to a first embodiment;

FIG. 2 is a block diagram showing the construction of the moving picture imaging apparatus and a data path when a reproduced image is displayed only on a display unit 111 according to the first embodiment;

FIG. 3 is a block diagram showing the construction of the moving picture imaging apparatus and a data path when the d reproduced image is displayed on an externally connected display device and on the display unit 111 according to the first embodiment;

FIG. 4 is a block diagram showing the construction of the moving picture imaging apparatus and another method of creating sub image data according to the first embodiment;

FIG. 5 is a flow chart showing a recording operation; and

FIG. 6 is a flow chart showing a reproduction operation.

### DESCRIPTION OF THE EMBODIMENTS

An embodiment of the present invention will be described below.

### Embodiment 1

In a system according to the present invention, examples of an imaging apparatus include a digital video camera, a digital still camera, a mobile telephone equipped with a camera function, a mobile PC equipped with a camera function, a PDA, and other devices capable of taking images. It is preferable that the imaging apparatus is portable and can be carried by a user. In addition, examples of an information processing apparatus include equipment for processing information, such as a HDD recorder, a disc recorder, a home server, and the like.

In the present embodiment, the imaging apparatus will be described by taking a moving picture imaging apparatus as an example. The information processing apparatus will also be described by taking a server device as an example.

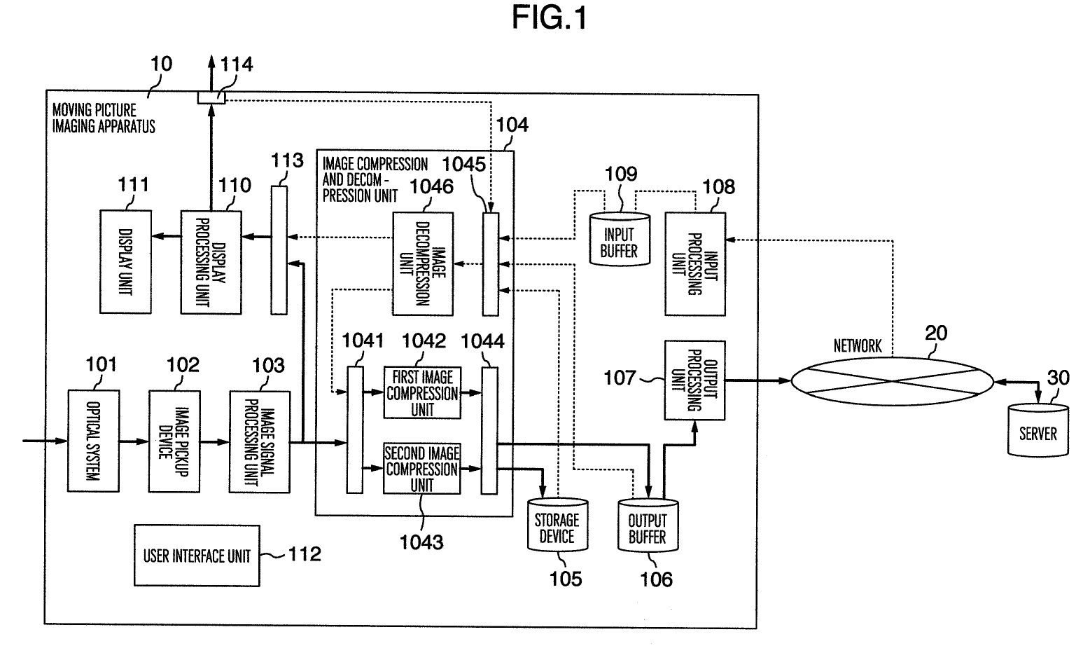

FIG. 1 shows the moving picture imaging apparatus, the server device, and a configuration when they are applied to a television device that allows viewing of a photographed video.

The moving picture imaging apparatus 10 comprises an optical system 101, an image pickup device 102, an image signal processing unit 103, an image compression and decompression unit 104, a storage device 105, an output buffer 106, an output processing unit 107, an input processing unit 108, an input buffer 109, a display processing unit 110, a display unit 111, a user interface unit 112, a selector 113, and a connector 114. In addition, the image compression and decompression unit 104 comprises a selector 1041, a first image compression unit 1042, a second image compression unit 1043, a selector 1044, a selector 1045, and an image decompression unit 1046.

The operation of the moving picture imaging apparatus 10 will be described hereinafter. Light emitted from a subject (not shown) is first gathered by the optical system 101. The optical system 101, which is not shown in detail here, comprises a plurality of lenses, a motor for moving the lenses for focusing and magnification adjustment purposes, and a control system or the like for controlling these units.

The light gathered by the optical system 101 is converted into an electrical signal by the image pickup device 102. The image pickup device 102 comprises, in addition to an imaging unit such as a CCD, an a CMOS for actually gathering light, an AD conversion circuit for sampling the analog electrical signal to convert it into a digital electrical signal, an AGC circuit for performing gain adjustment according to the ambient amount of light, a timing generator for supplying a timing signal for driving the image pickup device, a control circuit for controlling these units, and the like.

The video signal that is converted into the digital electrical signal by the image pickup device 102 is subjected to noise reduction processing, enhancement processing, conversion processing in which raw data (RGB format) from the image pickup device 102 is converted into a luminance signal and two kinds of color-difference signals, and the like. Then, the video signal is supplied to the image compression and decompression unit 104. The image signal processing unit 103 comprises, for example, a dedicated LSI or the like.

The image compression and decompression unit 104 has a function to scale down or scale up a video signal to a predetermined image size, compress or encode it according to a predetermined moving picture compression standard, such as MPEG-2, MPE-4, and H.264, and then output it, as a compressed video signal, to the storage device 105 or the output buffer 106. The image compression and decompression unit 104 has also a function to decompress the compressed video signal, which is inputted from the storage device 105 or the input buffer 109, according to the predetermined moving picture compression standard and output it to the display processing unit 110 as a video signal. The operation of the image compression and decompression unit 104 will be described later. It should be noted that the image compression and decompression unit 104 comprises a dedicated circuit such as an ASIC. The storage device 105 may be a nonremovable storage, such as a HDD and a flash memory, equipped to the moving picture imaging apparatus 10, or may be a removable storage device, such as a DVD, a BD, an SD card, and a magnetic tape.

The output buffer 106 and input buffer 109 comprise, for example, a volatile memory, a storage device and a buffer device structured to be nonremovable, which are not shown. The display unit 111 comprises, for example, a liquid crystal display, an organic EL display, and other display devices.

The output processing unit 107 reads out a compressed video signal from the output buffer 106 and outputs the read out video signal to a network. The input processing unit 108 inputs the compressed video signal from the network for writing into the input buffer 109.

The display processing unit 110 scales up or scales down the inputted video signal to a size suitable for display and outputs it to the display unit 111 that comprises a liquid crystal display or the like. The display processing unit 110 also converts, at the same time, the video signal into a suitable image size and format and outputs it to a connection terminal of external equipment (e.g., S terminal, D terminal, HDMI terminal or the like), which is not shown in FIG. 1.

The output processing unit 107, input processing unit 108, and display processing unit 110 comprise, for example, a processing circuit, such as an FPGA and an ASIC.

The user interface 112 is equipped with buttons that allow the user to control the operation of the moving picture imaging apparatus 10. The buttons include, for example, a switch for turning on/off power supply, a play/stop button, a recording start button, a button for switching between various modes, and the like.

A feature of the moving picture imaging apparatus 10 described in the present embodiment is as follows. Upon receipt of instructions from the user, via the user interface 112, to start recording, the moving picture imaging apparatus 10 starts recording, performs compression processing by the first image compression unit 1042, generates main image data, outputs it to the network through the buffer 106 and processing unit 107. At the same time, the moving picture imaging apparatus 10 performs compression processing to create sub image data while reducing the size, frame rate, bit rate or the like of the image by the second image compression unit 1043, and records this in the storage device 105. Another feature of the moving picture imaging apparatus 10 described in the present embodiment is that the main image data and sub image data are managed in pairs.

The operations of the moving picture imaging apparatus 10 will be described in detail hereinafter.

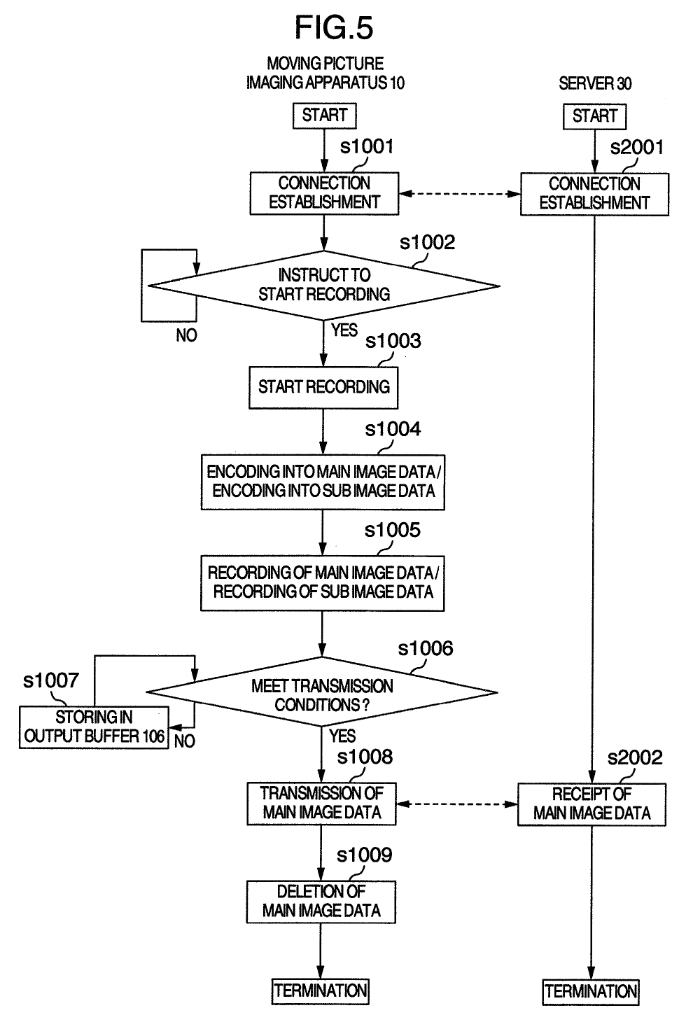

First, a recording operation will be described. A thick solid line in FIG. 1 shows a path of the recording operation. FIG. 5 shows a flow chart of the operation of the moving picture imaging apparatus 10 and a server device 30.

First, when the power of the moving picture imaging apparatus 10 is turned on, the moving picture imaging apparatus tries to establish a connection to the network. The connection to the network may be made in any manner, including via the telephone network or via the Internet. In addition, the network may be wireless or wired. However, in order to allow the user to employ the moving picture imaging apparatus while carrying it, it is desirable that the network is wireless. Here, a wireless connection to the Internet will be described. The moving picture imaging apparatus searches for a neighboring access point and establish a communication network link.

At that time, when, for example, a plurality of access points are detected, this is displayed on the display unit 111, and the user is prompted, through the user interface unit 112, to select an access point. When the user operates the user interface 112 to make connection to any access point, an attempt is made to make connection to a designated access point. If the connection to the designated access point is successful, then the display unit 111, or an LED or the like which is not shown in FIG. 1 informs the user that the connection has been established.

Alternatively, when there exists a fixed access point (e.g., an access point used at home), an attempt is made to make a connection to the access point. If the connection is successful, then the display unit 111, or the LED or the like which is not shown in FIG. 1 informs the user that the network link has been established.

Further, alternatively, when authentication, such as WEP (Wired Equivalent Privacy) or WPA (Wi-Fi Protected Access) is required, the moving picture imaging apparatus 10 displays this onto the display unit 11, and prompts the user to input authentication information through the user interface unit 112. The user may directly enter an authentication key through the user interface 112. Alternatively, the user may use, for example, the following method. The user's fingerprint information is previously associated with an authentication key, and is stored. If, as a result of reading out the user's fingerprint information by a fingerprint sensor (not shown), the user's fingerprint information matches the authentication key, then this is regarded as equivalent to entering the authentication key. Alternatively, a card or the like for authentication purpose is prepared separately, and authentication may be made by inserting this card or the like into a card slot which is equipped to the moving picture imaging apparatus 10. If, as a result of the authentication, the connection to the access point is authorized, then establishment of network link is attempted. If the network link is successfully established, then the display unit 111, the LED or the like (not shown in FIG. 1) informs the user of the successful network link establishment. If the authentication is not successful, then the result is outputted to the display unit 111 and the user is prompted to reenter the authentication information.

If the moving picture imaging apparatus 10 succeeds in the establishment of network connection according to the foregoing procedure, then the moving picture imaging apparatus 10 attempts to establish a connection to the server 30. If authentication is required for the connection, authentication is performed in the same manner as the connection to the access point. When a plurality of servers are available to which connection can be established, one predetermined server may be selected for connection, or a server may be selected by the user who selects the server after being informed of the availability of the plurality of servers through the display unit 111. The foregoing procedure allows the moving picture imaging apparatus 10 to be connected to the sever 30 (s1001, s2001).

If the moving picture imaging apparatus 10 is connected to the server 30 via the network 20 according to the foregoing procedure, the moving picture imaging apparatus 10 inquires about the storage space of a storage device available for recording out of storage devices (not shown in FIG. 1) equipped to the server. Upon receipt of a reply from the server 30, the moving picture imaging apparatus 10 calculates a recordable time period from the amount of storage available for recording, a recording mode, and the like. Then, the moving picture imaging apparatus 10 waits for instructions from the user on when to start recording after displaying the calculation result on the display unit 111 (s1002).

Even when the moving picture imaging apparatus 10 could not eventually be connected to the server 30, the moving picture imaging apparatus 10 calculates the recordable time period from the free space of the output buffer 106, the recording mode, and the like. Then, the moving picture imaging apparatus 10 waits for instructions from the user on when to start recording after displaying the calculation result on the display unit 111 (s1002).

The establishment of connection may be configured to be performed every time a predetermined amount of image data is recorded after the image recording is started, in addition to the time when the power of the moving picture imaging apparatus 10 is turned on. This configuration allows reduction of a time period during which the network connection is established, when communication speed of the network is high as compared with the amount of the image data which is recorded per unit time. A configuration may be adopted in check is periodically made to determine whether the connection is established. A configuration may also be adopted in which the establishment of connection is started according to the instructions from the user.

When the user gives the instructions to start recording through the user interface unit 112 at s1002, the recording operation is started (s1003). To put it another way, the light emitted from the subject enters the image compression and decompression unit 104 after passing through the optical system 101, the image pickup device 102, and the image signal processing unit 104. When the instructions to start recording is not given at s1002, the moving picture imaging apparatus 10 continues to wait for the instructions to start recording.

The image compression and decompression unit 104, as described above, comprises the first image compression unit and the second image compression unit, and the video signal inputted from the image signal processing unit 103 is inputted into both of the first image compression unit 1042 and second image compression unit 1043 at the same time through the selector 1041.

The first image compression unit 1042 encodes the inputted video signal into main image data (s1004). More specifically, the first image compression unit 1042 shapes the inputted video signal into the video signal, as a main image, having a predetermined size and frame rate (e.g., a size of 1920 pixels×1080 pixels, 30 frames per second, or the like), and performs compression in accordance with a predetermined moving picture compression standard (for example, H.264 High Profile is often employed for the image signal having the image size as described above) and the main image data is created. The created main image data is outputted to the output buffer 106 through the selector 1044. The outputted main image data is recorded in the output buffer 106 (s1005). It should be noted that the recording in the present embodiment includes temporally recording.

Simultaneously with the creation of the main image data by the image compression unit 1042, the second image compression unit 1043 encodes the inputted image signal into sub image data (s1004). More specifically, the second image compression unit 1043 shapes the inputted image into a image, as a sub image, with a predetermined size and frame rate (e.g., 320 pixels×180 pixels, 15 frames per second) and performs compression in accordance with a moving picture compression standard (e.g., H.264 Baseline Profile or the like in case of the image with the foregoing image size) and creates the sub image data. The created sub image data is outputted to the storage device 105 through the selector 1044. It should be noted that the size of the sub image data is smaller than that of the main image data. The outputted data is recorded in the storage device 105 (s1005).

Here, the first image compression unit 1042, the second image compression unit 1043, and the output processing unit 107 have functions to create and edit an image data management file. Examples of the form of the management file include a form in which a unique identifier is previously assigned to the image data, and management is performed based on whether a pair of the identifier and image data having the identifier are stored in the storage device 105 (the number of bytes from the front end of the region, a sector address of the storage or the like).

The data management file is also held on the server 30 side. The server 30 performs management based on a pair of the identifier unique to the image data and a position (the number of bytes from the front end of the region, a sector address of the storage, or the like) within the storage of the server 30 where the identifier is stored. However, the specific form of the management file is not considered in the present embodiment.

When the main image data is written into the output buffer 106 by the image compression and decompression unit 104, the main image data management file for managing the main image data is first edited. Then, information indicating on which position of the output buffer 106 the front end position of the main image data, which is currently under creation, is located is written into the main image data management file. In addition, when a medium, into which the sub image is written, is a removable medium, such as a DVD or a BD, which will be described later, information on an identifier (e.g., a disc ID) for identifying the medium is also written into the main image data management file.

Once the main image data is written into the output buffer 106, the output processing unit 107 determines whether the main image data meets transmission conditions (s1006). For example, the output processing unit 107 determines whether a connection is established between the moving picture imaging apparatus 10 and the server 30 via the network 20. The output processing unit 107 monitors the amount of data of the main image data stored in the output buffer 106, and determines whether a certain amount of the main image data is accumulated in the output buffer 106 and is ready for being outputted to the network 20.

When the transmission conditions are met, the output processing unit 107 reads out the main image data stored in the output buffer 106, and transmits the main image data to the server 30 via the network 20 (s1008), after performing packetizing processing or the like to the main image data as required. If the transmission conditions are determined not to be met at s1006, the output buffer 106 continues to accumulate the main image data (s1007). For example, when the connection between the moving picture imaging apparatus 10 and the server 30 is not established, the main image data is stored in the output buffer 106, and continues to be accumulated until the receipt of instructions to stop recording from the user or until the entire space secured for the output buffer 106 is filled with the main image data.

During the transmission of the main image data from the output processing unit 107 to the server 30, the server 30 edits the main image data management file held on the server side, and writes the position within the storage device of the server 30 where the front end position of the main image data, which is currently under transmission, is located into the main image data management file on the server side. In addition, when a medium, into which the sub image is written, is a removable medium, such as a DVD or a BD, which will be described later, information on an identifier (e.g., a disc ID) for identifying the medium is also written into the main image data management file on the server side.

When the output processing unit 107 finishes transferring of the entire image data stored in the output buffer 106 to the server 30 at s1008, the output buffer 106 deletes the transferred main image data (s1009). The output processing unit 107 also edits the main image data management file on the output buffer 106 side, and eliminates the identifier and information on the position of the transferred the main image data.

When the connection between the moving picture imaging apparatus 10 and the server 30 is disconnected due to a change in communication environment or the like during the transfer of the main image data from the output processing unit 107 to the server 30, the output processing unit 107 edits the main image data management file on the output buffer side, and rewrites the front end position of the main image data to a position where the transfer of the main image data has not been completed.

When the image compression and decompression unit 104 outputs the main image data to the output buffer 106, the output buffer 106 first edits the main image data management file, and writes the position within the output buffer 106 where the front end position of the main image data, which is currently under creation, is located into the main image data management file.

During the writing of the sub image data into the storage device 105 by the image compression and decompression unit 104, the sub image data management file for managing the sub image data is edited, and the position within the storage device 105 where the front end position of the sub image data, which is currently under creation, is located is written into the sub image data management file.

Identifiers are added to the sub image data management file and the main image data management file such that the main image data and the sub image data, which are generated from the same video signal, are related to each other.

As described above, the storage device 105, output buffer 106, and output processing unit 107 perform processing such that the main image data is deleted, while the sub image data is held in the storage device 105 without being deleted even after the main image data is transferred. In other words, the moving picture imaging apparatus 10 transfers and deletes only the main image data of the sub image data and main image data.

It should be note that the main image data may be transferred after it is once recorded on the storage device 105 and read out by the output buffer 106.

The digital video signal outputted from the image signal processing unit 103 is also supplied to the display processing unit 110 through the selector 113. The display processing unit 110 performs required image processing, such as an image size adjustment and a format conversion, and then outputs it to the display unit 111 for presentation to the user. This allows the user to view the image which is currently being photographed.

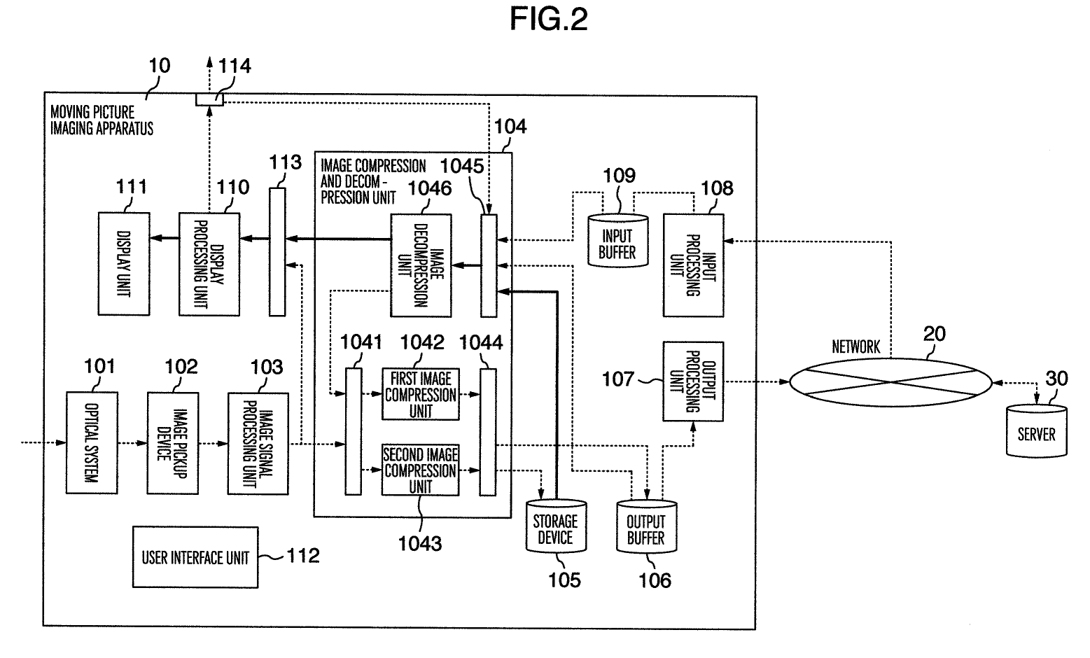

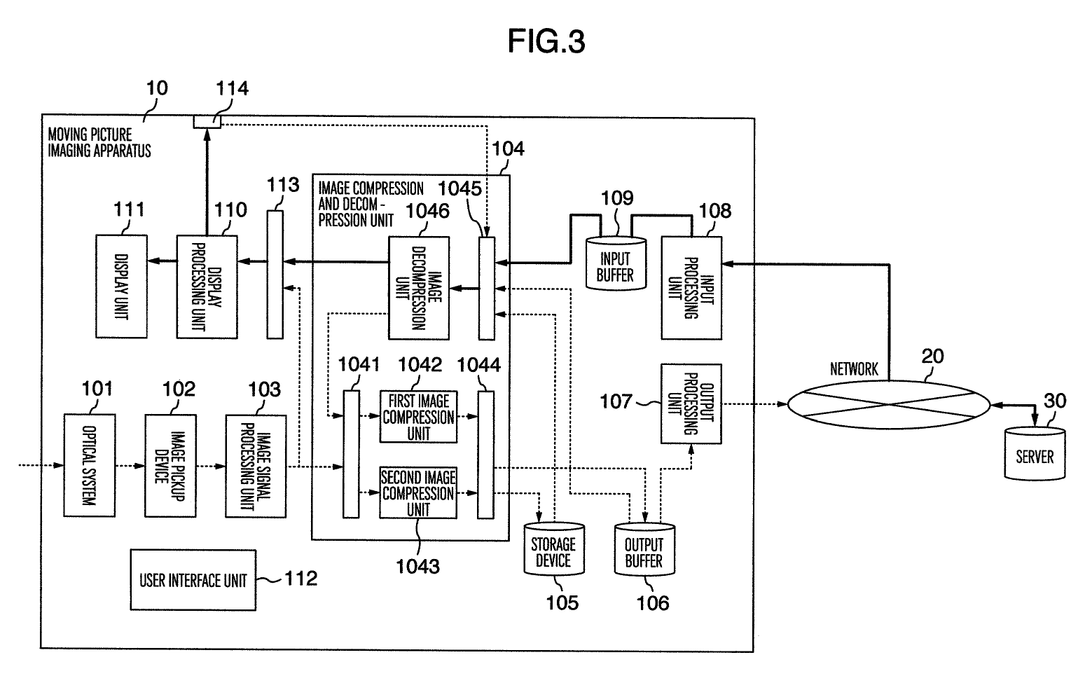

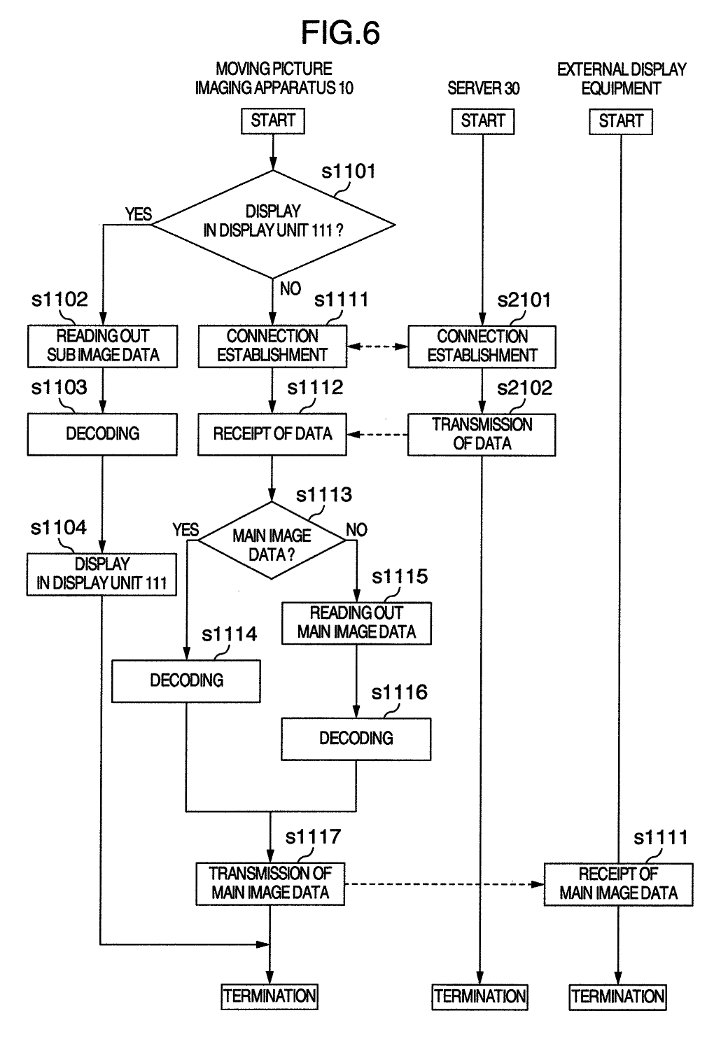

Next, the reproduction operation by the moving picture imaging apparatus 10 will be described. The path of the reproduction operation is described by a thick solid line in FIG. 2 and FIG. 3. FIG. 6 shows a flow chart of the reproduction operation.

First, when the reproduction operation starts, the moving picture imaging apparatus 10 determines whether to perform reproduction only by the display unit 111 or by external display equipment (s1101). Specifically, the determination may be performed as follows. When external display equipment is not connected to a connector 114, the display is performed only by the display unit 111, and when the external display equipment is connected to the connector 114, the display is performed by the external display equipment. In this case, when the external display equipment is connected to the connector 114, a configuration may be made such that information to the effect that the external display equipment is connected to the connector 114 is sent to a selector within the image compression and decompression unit 104, and the image compression and decompression unit 104 makes a switch to choose a video signal to be processed. In addition, the determination at s1101 may be performed by the user. That is, the user determines through the operation of the user interface unit 112 whether to perform reproduction only by the display unit 111 or by the external display equipment.

Here, a case will be considered in which a photographed image is displayed on the display unit 111 equipped to the moving picture imaging apparatus 10. This is based on the assumption that an image taken outdoors, for example, is displayed on the spot. Generally, the size of the moving picture imaging apparatus 10 is small enough to be portable. Therefore, a compact liquid crystal display, such as 2 to 4 inches, is sometimes used for the display unit 111. There are two ways of displaying images on such a compact display unit. One is to display a large-sized main image after scaling it down. The other is to display a sub image that is originally small. A significant visual difference cannot be seen between the two.

A case of “yes” at s1001, or, more specifically, an operation that is reproduction is done by the moving picture imaging apparatus 10, the display unit 111 is the only device to display and the video signal is reproduced in the display unit 111, will be described with reference to the data path shown in FIG. 2. In this event, the recorded sub image data is read out from the storage device 105 (s1102). Then, the sub image data is inputted into the image decompression unit 1046 through the selector 1045, decompressed according to an image compression standard, and decoded into a video signal (s1103). Thereafter, the decoded video signal is displayed on the display unit 111 by the display processing unit 110.

In a case of “no” at s1101, or, more specifically, when the reproduced image is displayed not only on the display unit 111 but also on the external display equipment, including a television device, the image quality of the sub image data stored in the storage device 105 is likely to be rough. Therefore, it is required that the main image existing in the server 30 is transferred via the network and is reproduced.

The operation performed in this case will be described with reference to the data path in FIG. 3 and a flow chart in FIG. 6. In this event, first, a connection is established between the moving picture imaging apparatus 10 and the server 30 via the network 20 (s1111, s2101). Its procedure is the same as that of the recording. Therefore, the description thereof is omitted here.

When the moving picture imaging apparatus 10 and the server 30 are connected via the network 20, the output processing unit 107 refers to the main image data management file on the server side to search for the main image data desired to be reproduced from the data accumulated in the server 30.

When there exists relevant main image data in the server 30, the server 30 transmits the main image data to the moving picture imaging apparatus 10 via the network (s2102). When there does not exist the relevant main image data in the server 30, the server 30 transmits data indicating no existence of the main image data therein to the moving picture imaging apparatus 10 via the network (s2102).

The moving picture imaging apparatus 10 receives the transmitted data by the input processing unit 108 (s1112).

The input processing unit 108 determines whether the received data is the main image data (s1113). If the inputted data is the main image data, then the input buffer 109 stores the inputted data. If the inputted data is not the main image data, then the input buffer 109 outputs data indicating that the inputted data is not the main image data to the image compression and decompression unit 104 via the input buffer.

If it is determined that the received data is the main image data, a predetermined amount of the data or more is accumulated in the input buffer, and the data can be reproduced by the image decompression unit 1046 without any delay, then the main image data is read out from the input buffer 109. Thereafter, the data is supplied to the image decompression unit 1046 through the selector 1045, and decompressed, thus being decoded into a video signal (s1114).

If the image compression and decompression unit 104 receives data indicating that inputted data is not the main image data, the selector 1045 is switched, and the main image data management file contained in the output buffer 106 is referred to, and the main image data desired to be reproduced is read out from the data accumulated in the output buffer 106 (s1115). Then, the main image data is supplied to the image decompression unit 1046 and decompressed, thus being decoded into the video signal (s1116).

The video signal decoded at s1114 or s1116 is sent to the display unit 1111 by the display processing unit 110, or transmitted to external display equipment, such as a television device (not shown), which is connected to the display processing unit 110 via the connector 114 (s1117). The external display equipment also receives the video signal transmitted by the moving picture imaging apparatus 10 (s3101).

In the flowchart of FIG. 6, the moving picture imaging apparatus 10 is configured to read out the main image data from the output buffer 106 at s1115 after receiving the data indicating no existence of the main image data from the server 30. However, a configuration may also be adopted in which, for example, the moving picture imaging apparatus 10, first, searches for the main image data within the output buffer 106, and if the main image data does not exists in the storage device, then the moving picture imaging apparatus 10 establishes a connection to the server 30 to search for the main image data in the server 30. This configuration enables the transmission of the main image data to the external display equipment without connecting to the server 30, when the main image data exists in the output buffer 106. This makes it possible to reduce communication amount.

There is also a case in which the main image data does not exist in the server 30 nor in the output buffer 106. This takes place, for example, when the main image data is deleted also in the server 30 after the main image data is transmitted from the moving picture imaging apparatus 10 to the server 30 and deleted from the output buffer 106. In this case, the moving picture imaging apparatus 10 may be configured to decode the sub image data within the storage device 105 and transmit it to the external display equipment. This configuration enables the outputting of a video having an image quality of the sub image data to the external display equipment, even if the main image data can not be found.

There is also a case in which the connection is not established between the moving picture imaging apparatus 10 and the server 30 at s1111, and the main image does not exists even in the output buffer at s1102. In this case, it is unknown whether the main image data exists in the server 30. To cope with this, the moving picture imaging apparatus 10 may be configured to decode the sub image data within the storage device 105 and then transmit it to the external display equipment. This configuration allows the video having an image quality of the sub image data to be outputted to the external display equipment, even if the main image data can not be found in the output buffer 106 because of a failure in the connection establishment.

In the preceding description, an example has been described in which the moving picture imaging apparatus 10 transmits the main image data to the external display equipment after decoding it into a video signal. However, the external display equipment has sometimes the image decompression device or image decoding device. Therefore, the moving picture imaging apparatus 10 may be configured to transmit the main image data without decoding it into the video signal.

Next, an editing operation performed by the moving picture imaging apparatus 10 will be described.

When the user uses the moving picture imaging apparatus 10 to perform an editing operation, the user first edits the sub image stored in the storage device 105, and simultaneously records the content of the editing performed to the sub image and writes it into the output buffer 106. The user also performs the same editing operation to the main image data.

For example, when eliminating the image data that is already recorded, relevant sub image data is first extracted from the sub image data stored in the storage device 105, and eliminated. Simultaneously thereto, editing information (elimination in this case) indicating the identifier of the relevant sub image data and editing content is recorded.

Subsequently, the same editing is performed to the corresponding main image data. First, a search is made to determine whether the corresponding main image data exists in the output buffer 106. If it exists, the main image data is edited in the same manner. Next, the identifier of the main image data to be edited and the content of editing operation thereof are written in pairs into the output buffer 106. The type of data is not particularly limited. For example, a type is also acceptable in which data is embedded into a MPEG2 TS packet. Other types are also acceptable.

If the connection to the server 30 is established, the output processing unit 107 transfers the data, in which the identifier of the main image data to be edited and the content of editing are written, to the server 30 via the network 20. The server 30 analyses the content of the data to check whether corresponding main image data exists in the storage owned by the server 30. If it exists, the main image data is edited in the same manner.

The delete operation has been explained in the preceding description, and other editing operations, including, for example, coupling of two pieces of image data, separation of image data, and addition of special effects, are performed in the same manner.

It should be noted that the moving picture imaging apparatus 10 may be configured to add additional data to the main image data through the output processing unit 107 or the like, during the transmission of the main image data from the moving picture imaging apparatus 10. In this event, the additional data is, for example, information indicating that the deletion of the image data is prohibited, or that the image data is captured by the moving picture imaging apparatus 10. Alternatively, the server 30 may be configured to add the additional data to the image data inputted by the moving picture imaging apparatus 10. A control means of the server 30 performs control to limit the editing operation, such as deletion, to the main image data to which the additional data is added. Here the limitation means, for example, the prohibition of editing operations. In addition, the server 30 may be configured to output the content of the additional data, together with the main image data, to the external display equipment and display device. This makes it possible to reduce the possibility that the user edits the corresponding main image data even though sub image data remains in the moving picture imaging apparatus 10. Alternatively, this allows the user to recognize the reason why the server can not edit the main image data.

In addition, even when an edition operation is performed to the main image data by the server 30, the editing operation may be limited by performing control such that both edited main image data and unedited main image data are left, and the unedited main image data is held and controlled until the server 30 gets synchronized with the moving picture imaging apparatus 10. Here, the synchronization indicates, for example, that the moving picture imaging apparatus 10 performs the same editing operation as that performed by the server 30. In this event, the moving picture imaging apparatus 10 may be configured to accept, by an operation unit, the operation by the user to permit the reflection of the editing operation by the server 30. In addition, a configuration may also be adopted in which after the moving picture imaging apparatus 10 gets synchronized with the server 30, the server 30 eliminates the unedited main image data. This configuration makes it possible to improve the usefulness of the image data management.

A case is also conceivable in which the server 30 edits the main image data. In this event, when the server edits the main image data, a history of editing operations performed by the server 30 may be configured to be recorded and transferred to the moving picture imaging apparatus 10.

Alternatively, when the moving picture imaging apparatus 10 attempts to download the main image data from the server 30, there is often a case in which the main image data has already been deleted from the server 30. In this event, the moving picture imaging apparatus 10 may be configured to display the information, indicating that the main image data has already been deleted, on the display unit 111, and to display the information inquiring whether or not to eliminate the sub image data from the storage device 105.

As described in the foregoing, the moving picture imaging apparatus 10 of the present embodiment transfers the main image data, which is conventionally stored in the storage device equipped to the apparatus body, to the server via the network 20, and keeps only the sub image for display and editing in the main body. This allows the moving picture imaging apparatus 10 to take photographs without worrying about storage capacity of the main body. In addition, the main image data is concentrated in the storage device equipped to the server 30, thus providing an advantage that the photographed video can be managed in an integrated manner.

In order to utilize such an advantage, the moving picture imaging apparatus 10 of the present embodiment may have a function to transfer the main image data in the background, if the main image data has not been transferred and remains in the output buffer 106, and the moving picture imaging apparatus 10 can be connected to the server 30 via the network 20 when the moving picture imaging apparatus 10 is, for example, in an idle state. In addition, when performing the transfer operation in the background, the moving picture imaging apparatus 10 may have a function to select between the two: performing the transfer when the moving picture imaging apparatus 10 is connected to a power receptacle; and not performing the transfer when the moving picture imaging apparatus 10 is battery-driven.

In the operation of the moving picture imaging apparatus 10 that has been described in the preceding section, the main image data is configured to be generated by the first image compression unit, and sub image data is configured to be generated by the second image compression unit. However, a configuration may also be adopted in which the main image data is first created, transferred to the output buffer 106, read out, and decoded by the image decompression unit 1046, and then it is inputted into the second image compression unit 1043 and the sub image data is generated.

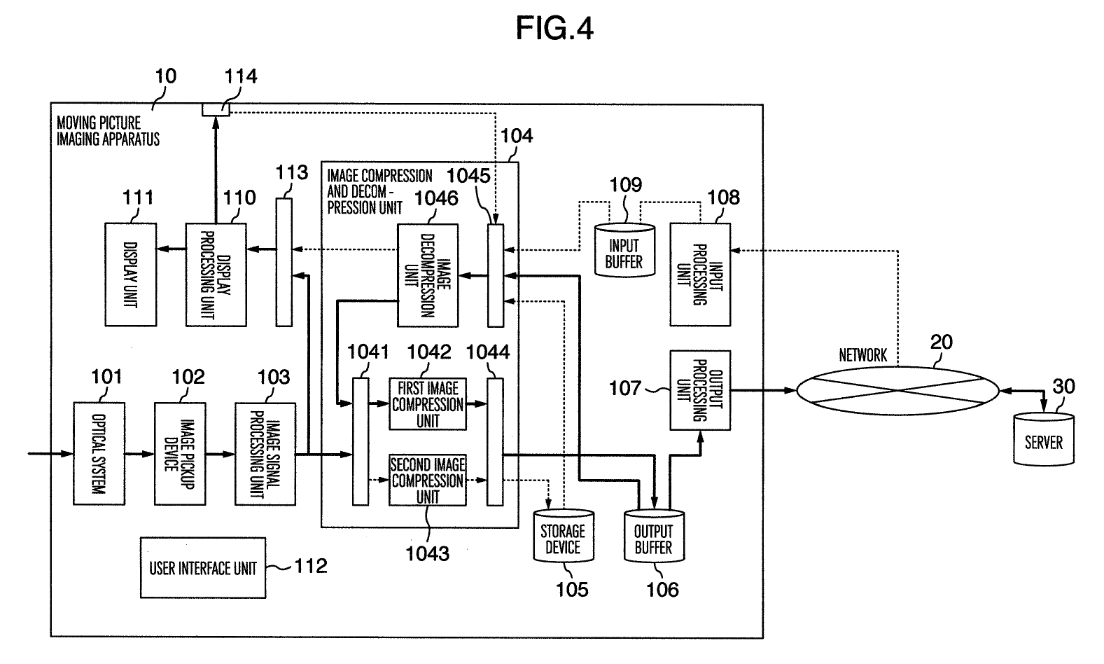

The main image data may be inputted into the first image compression unit 1042, instead of being inputted into the second image compression unit 1043, and compressed. The operation performed in this case will be described with reference to FIG. 4. The data path is indicated by a thick solid line. That is to say, the first image compression unit 1042 is time-shared, and control is made such that the main image data is created in some time zone, and the sub image data is created in another time zone. In conjunction with this, a selector 1041 makes a switch between the video signal inputted from the image signal processing unit 103 and the video signal inputted from the image decompression unit 1046 for supplying to the first image compression unit 1042, thus making it possible to generate the main image data and the sub image data. In this event, in order to reduce the circuit scale as well as power consumption, the second image compression unit 1043 which is not involved in the operation may be removed.

In the preceding section, description has been made based on the assumption that the sub image data is moving images. However, the sub image data may be still images. In other words, the sub image data that has been described so far as may be still image data, such as, for example, thumbnail image data that appears on the beginning of a scene. A case will be described below as an example in which the sub image data is the thumbnail image data.

For example, when the user uses the moving picture imaging apparatus to perform reproduction operation, some thumbnail image data are first read out from the storage device 105, and are decompressed by the image decompression unit 1046, thus thumbnail images being created. Then, they are on-screen displayed in an appropriate manner and shaped by the display processing unit 110, and then displayed on the display unit 111.

Then, the user uses the user interface 112 to select the thumbnail image corresponding to the main image data desired to be reproduced from a plurality of thumbnail images. Then, the input processing unit 108 searches for the main image data related to the thumbnail image from the output buffer 106 or from the server 30 via the network 20, and the searched main image data is transferred to the input buffer 109. The subsequent operation is performed in the same manner as performed in the reproduction operation. That is to say, the reproduced image is displayed on the display unit 111, or on the external display equipment that is externally connected after it is passed through the image decompression unit 1046 and the display processing unit 110.

Alternatively, the content of the sub image data, which has been described so far, may also be a management information file (e.g., an IFO file in a DVD-VR standard)

For example, the management information file stored in the storage device 105 can be rewritten appropriately by a host CPU or the like (not shown) based on the instructions given from the user through the user interface, thus making it possible to rewrite a play list without reading out the main image data from the server 30.

When, thereafter, the main image data is reproduced following the play list created as above described, the input processing unit 108 searches for a stream designated by the play list from the output buffer 106 or the server 30 to perform continuous reproduction in accordance with reproduction procedure that has been described so far, thus making it possible to implement the reproduction of the play list.

As just described, the sub image data does not necessarily need to be the moving image data. The sub image data may be a still image, a management file, or other information relating to the main image data.

While the present embodiment has been described by taking the moving image data, such as the main image data and sub image data, as an example, it is not limited to the moving image data. The present embodiment is also applicable to a portable sensing apparatus that generates data, ranging from data that can be obtained by a sensor, such as voice, image, text, and others, to large-sized data and small-sized data. After the large-sized data is related to the small-sized data, the large-sized data is transmitted to the server. This enables the power consumption of the portable sensing apparatus, during the use of a function to display data or the like, to be reduced, while the free space of a recording medium in the portable sensing apparatus is maintained. Furthermore, this makes it possible to facilitate the data management in the server.

While the present embodiment has been described by taking a case, in which the main image data and sub image data are generated by compression-coding an inputted video signal, as an example, the method of generating the main image data and sub image data is not limited to the compression-coding. For example, a configuration may also be adopted in which the inputted video signal is subjected to some kind of conversion coding (e.g., wavelet conversion), and a low-order component is assumed to be the sub image data, with a high-order component being assumed to be the main image data. This configuration eliminates the need of image contraction processing, which is required when generating the sub image data, and can help reduce throughput and circuit scale.

In addition, the configuration of the present invention is not limited the foregoing embodiment and can be modified freely within the scope of the present invention.

1. A video recording system having an imaging apparatus and an information processing apparatus, wherein said imaging apparatus comprises:
imaging means for imaging an image to produce a video signal;
first encoding means for coding the video signal to generate first compressed video information;
second encoding means for coding the video signal to generate second compressed video information having a smaller information volume than that of said first compressed video information;
recording means for recording said first compressed video information and second compressed video information onto a recording medium;
outputting means for outputting said first compressed video information to said information processing device;
decoding means for decoding said second compressed video information to output said video signal;
display means for displaying said video signal which is outputted by said decoding means; and
processing means for performing processing such that when said first compressed video information is outputted by said outputting means, said second compressed video information is held in said recording medium, and said first compressed video information is deleted from said recording medium, and wherein:
said information processing device records said first compressed video information which is inputted from said imaging apparatus.

2. The video recording system according to claim 1, wherein:
said outputting means outputs said first compressed video information to said information processing device via a network.

3. The video recording system according to claim 1, wherein:
said decoding means decodes either said first compressed video information or said second compressed video information depending on an operation mode.

4. The video recording system according to claim 1, wherein:
said imaging apparatus comprises inputting means for inputting said first compressed video information from said information processing device,
said decoding means decodes the first compressed video information to output a video signal; and
said processing means performs processing such that when said external display equipment is connected to said imaging apparatus, said first compressed video information, which is inputted by said inputting means, is decoded by said decoding means, and said video signal, which is outputted by said decoding means, is displayed on said external display equipment, and when said external display equipment is not connected to said imaging apparatus, said second compressed video information is decoded by said decoding means, and said video signal is displayed on said display means.

5. The video recording system according to claim 1, wherein:
said imaging apparatus comprises editing information recording means for recording editing information indicating an editing operation that is performed to said second compressed video information,
said outputting means outputs said editing information to said information processing device; and
said information processing device performs an editing operation, which is indicated by said editing information which is inputted, to said first compressed video information.

6. The video recording system according to claim 1, wherein:
said imaging apparatus comprises adding means for adding additional information, which indicates that said compressed video information is captured by the imaging apparatus, to the first compressed video information outputted by said means; and
said information processing device limits the editing operation with respect to said firs compressed vide information, when said additional information is added to the inputted first compressed video information.

7. The video recording system according to claim 1, wherein:
said first encoding means and said second encoding means encode the same video signal with encoding conditions that differ from each other.

8. The video recording system according to claim 1, wherein:
said second encoding means encodes a video signal which is generated by decoding said first compressed video information, which is previously encoded, in said decoding means.

9. An imaging apparatus, comprising:
imaging means for imaging an image to produce a video signal;
first encoding means for encoding said video signal to generate first compressed vide information;
second encoding means for generating second compressed video information having a smaller information volume than that of said first compressed video information by encoding;
recording means for recording said first compressed video information and second compressed video information in a recording medium;
outputting means for outputting said first compressed video information to external information processing device;
decoding means for decoding said second compressed video information to output a video signal;
display means for displaying the video signal outputted by said decoding means; and
processing means for performing processing such that when said first compressed video information is outputted by said outputting means, said second compressed video information is held in said recording medium, and said first compressed video information is deleted from said recording medium.

10. The imaging apparatus according to claim 9, wherein:
said outputting means outputs said first compressed video information to said external information processing device via a network.

11. The imaging apparatus according to claim 9, wherein:
said decoding means decodes either said first compressed video information or said second compressed video information depending on the operation mode.

12. The imaging apparatus according to claim 9, comprising:
inputting means for inputting said first compressed video information from said external information processing device, wherein:
said decoding means decodes said first compressed video information; and
said processing means performs processing such that when the external display equipment is connected to said imaging apparatus, said first compressed video information inputted by said inputting means is inputted into said decoding means and is decoded into the video signal, and said video signal is outputted to said external display equipment, and when said external display equipment is not connected to said imaging apparatus, said second compressed video information is inputted into said decoding means and is decoded into the video signal, and said video signal is displayed on said display means.

13. The imaging apparatus according to claim 9, comprising:
editing information recording means for recording editing information which indicates an editing operation that is performed to said second compressed video information, wherein:
said editing information is outputted by said outputting means.

14. The imaging apparatus according to claim 9, wherein:
said first encoding means and said second encoding means encode the same video signal with encoding conditions that differ from each other.

15. The imaging apparatus according to claim 9, wherein:
said second encoding means encodes the video signal that is generated by decoding said first compressed video information, which is previously encoded, into said decoding means.

16. An imaging apparatus, comprising:
imaging means for imaging an image to produce a video signal;
first encoding means for encoding said video signal to generate first compressed video information;
second encoding means for encoding said video signal to generate second compressed video information having a smaller information volume than that of said first compressed video information;
recording means for recording said first compressed video information and second compressed video information onto a recording medium;
outputting means for outputting said first compressed video information to an external information processing device;
decoding means for decoding said second compressed video information to output a video signal;
display means for displaying said video signal outputted by said decoding means; and
processing means for performing processing such that when said first compressed video information is outputted by said outputting means, only said first compressed video information, out of said first compressed video information and said second compressed video information, is deleted from said recording medium.

17. A display means, comprising:
imaging means for imaging an image to produce a video signal;
encoding means for encoding said video signal to generate compressed video information;
identification information generating means for generating identification information that has a smaller information volume than that of said compressed video information and that helps the user identify said compressed video information;
recording means for recording said compressed video information and identification information onto a recording medium;
outputting means for outputting said compressed video information to an external information processing device;
processing means for performing processing such that when said compressed video information is outputted by said outputting means, said identification information is held in said recording medium, and said compressed video information is deleted from said recording medium; and
display means for displaying said identification information.

18. A video recording system having an imaging apparatus and an information processing device, said imaging apparatus comprising:
imaging means for imaging an image to produce a video signal;
encoding means for encoding said video signal into first video information and second video information each having a different data volume;
decoding means for decoding said firs video information or said second video information to produce a decoded video signal; and
outputting means for outputting video information having a larger information volume of said first video information and said second video information to the outside of said imaging apparatus; wherein
said information processing device records video information having a larger information volume out of said first video information and second video information inputted from said imaging apparatus.

19. The video recording system according to claim 18, said imaging apparatus comprises:
display means for reproducing and displaying said decoded video signal; and
connection means for connecting an external display device to display and reproduce said decoded video signal onto said external display device, wherein:
when said decoded video signal is displayed only onto said display means, video information having a smaller information volume of said first video information and said second video information is decoded by said decoding means, and the decoded video signal is reproduced and displayed; and
when said decoded video signal is displayed on both of said external display device and said display means, either said first video information or said second video information is decoded by said decoding means, and the decoded video signal is reproduced and displayed.

20. The video recording system according to claim 18, said imaging apparatus comprising:
display means for reproducing and displaying said decoded video signal; and
connection means for connecting said external display device to display and reproduce said decoded video signal onto said external display device, wherein:
when said decoded video signal is displayed only on said display means, video information having a smaller information volume of said first video information and said second video information is decoded by said decoding means, and the decoded video signal is reproduced and displayed; and
when said decoded video signal is displayed on both of said external display device and said display means, both of said first video information and said second video information are combined and decoded by said decoding means, and the decoded video signal is reproduced and displayed.

21. The video recording system according to claim 18, said imaging apparatus comprising:
display means for reproducing and displaying said decoded video signal; and
connection means for connecting said external display device to display and reproduce said decoded video signal onto said external display device, wherein:
when said decoded video signal is displayed only on said display means, video information having a smaller information volume of said first video information and said second video information is decoded by said decoding means, and the decoded video signal is reproduced and displayed; and
when said decoded video signal is displayed on both of said external display device and said display means, part or all of said first video information and said second video information is combined depending on the resolution of said external display device and decoded by said decoding means, and the decoded video signal is reproduced and displayed.
